(19) United States
(12) Patent Application Publication
(10) Pub. No.: US 2020/0299204 A1
(43) Pub. Date: Sep. 24, 2020

(54) METHOD FOR RECOVERING VALUABLE SUBSTANCES

(71) Applicants: Michael SCHELCH, Oberaich (AT); Wolfgang STABER, Bruck an der Mur (AT)

(72) Inventors: Michael SCHELCH, Oberaich (AT); Wolfgang STABER, Bruck an der Mur (AT)

(21) Appl. No.: 16/753,297

(22) PCT Filed: Sep. 25, 2018
(86) PCT No.: PCT/EP2018/076020

§ 371 Date: Apr. 2, 2020

(30) Foreign Application Priority Data
Oct. 3, 2017 (AT) A50842/2017

(51) Int. Cl. C05C 3/00; C02F 11/00; C02F 11/18; C05F 7/00; C05F 3/00; C05F 1/00; C05F 5/00

(52) U.S. Cl. CPC C05C 3/00; C02F 11/006; C02F 11/18; C05F 7/005; C02F 2101/20; C05F 1/007; C05F 1/005; C05F 5/002; C05F 3/00

(57) ABSTRACT

The invention concerns a method for extracting valuable materials from organic compounds contained in waste or chemical elements contained therein.

The method comprises the following steps carried out in succession:
a) mixing the waste (1) with a base so that a liquid medium is formed,
b) heating the medium in a reactor (3) to a temperature of 100° C. to 140° C. in order to hydrolyse the organic compounds contained in the medium, and withdrawing (c) the vapour which is formed,
b1) transferring (c) the vapour from the reactor (3) to a washing tower (4),
b2) adding sulphuric acid or phosphoric acid (c′) to the vapour in order to form ammonium sulphate(s) or ammonium phosphate(s), wherein a solution is obtained in the bottom of the washing tower (4) and the vapour is withdrawn from the head of the washing tower (4),
b3) transferring (e) the solution obtained in step b2) to an electrochemical cell (6) with a cathode chamber and an anode chamber and electrolysing the solution, whereupon in the anode chamber, sulphuric acid or phosphoric acid is obtained for step b2),
b4) recycling (c′) the sulphuric acid or phosphoric acid obtained from the anode chamber to the washing tower and withdrawing (f) valuable materials formed in the cathode chamber, in particular an ammoniacal solution,
c) transferring (d) the liquid medium remaining in the reactor (3) in step b) to a separating device (5) in order to separate any solid inorganic phase which is contained in the liquid medium.

The invention concerns a method for extracting valuable materials from organic compounds contained in waste or chemical elements contained therein.

The term “waste” as used in the context of the present invention in particular includes sewage sludge, manure, dung from livestock, slaughterhouse waste, meat-and-bone meal, as well as organic waste or biomass. Waste of this type contains a plurality of complex chemical compounds and often has a very high water content. Examples of components of these compounds are amino groups or phosphate groups which constitute interesting molecular components having regard to extracting valuable materials. Because of the high water content of the waste as well as the complexity of the chemical compounds, economic recovery of the aforementioned molecular components, in particular extracting valuable materials from these molecular components, is currently only possible with difficulty. The problems are even greater when heavy metals and/or heavy metal salts are contained in the waste.

Sewage sludge contains, for example, nitrogen and phosphorus which are suitable for fertilization but, however, often high a large heavy metal content and/or content of residues of pharmaceuticals, and thus cannot be used or cannot be used directly as a fertilizer. Currently, the use of sewage sludge as a fertilizer in Europe is governed by guidelines which set the limits for the concentration of heavy metals. In addition, the spreading of sewage sludge as a fertilizer is forbidden in some regions. Separation of the heavy metals and/or heavy metal salts from sewage sludge is currently impossible for an economically acceptable outlay.

Sewage sludge which cannot be used as fertilizer is currently incinerated or gasified. The high water content of sewage sludge makes this an extremely energy-consuming and usually uneconomical form of use. The vapour which arises during the evaporation of sewage sludge is also difficult to treat subsequently. In particular, during evaporation, the molecular components which are suitable for valuable material extraction bound into the complex chemical compounds are lost.

In addition to sewage sludge, the processing or treatment of many other types of waste, particularly such as the waste mentioned above, is highly problematic. In addition, the waste is often pasty or solid in consistency, so that it is difficult to pump, and handling the waste is also a logistical challenge.

Thus, the objective of the invention is to provide a method which overcomes the aforementioned obstacles to use during the treatment of waste, and thus allows for an economical extraction of valuable materials from the waste.

The above objective is achieved in accordance with the invention by means of a method of the type defined above with the following steps being carried out in succession:
a) mixing the waste with a base so that a liquid medium is formed,
b) heating the medium in a reactor to a temperature of 100° C. to 140° C. in order to hydrolyse the organic compounds contained in the medium, and withdrawing the vapour which is formed,
   b1) transferring the vapour from the reactor to a washing tower,
   b2) adding sulphuric acid or phosphoric acid to the vapour in order to form ammonium sulphate(s) or ammonium phosphate(s), wherein a solution is obtained in the bottom of the washing tower and the vapour is withdrawn from the head of the washing tower,
   b3) transferring the solution obtained in step b2) to an electrochemical cell with a cathode chamber and an anode chamber and electrolysing the solution, whereupon in the anode chamber, sulphuric acid or phosphoric acid is obtained for step b2),
   b4) recycling the sulphuric acid or phosphoric acid obtained from the anode chamber to the washing tower and withdrawing valuable materials formed in the cathode chamber, in particular an ammoniacal solution,
c) transferring the liquid medium remaining in the reactor in step b) to a separating device in order to separate any solid inorganic phase which is contained in the liquid medium.

By means of steps a) and b) of the method in accordance with the invention, the organic compounds of the waste are taken up into solution in a liquid medium, so that a medium is obtained which is very easy to transport. Because the hydrolysis of step b) is carried out at a temperature of 100° C. to 140° C., organic salts are formed from the organic compounds contained in the medium without decomposition and in a high degree of conversion, and they dissolve in the liquid medium. At least the major proportion of any as yet non-hydrolysed organic compounds has a lower density than the remaining liquid medium, so that it floats on top of the medium. Valuable materials can be obtained from the vapour formed in step b), for example an ammoniacal solution from a vapour which contains nitrogen.

By means of steps b1) and b2), a solution containing ammonium sulphate(s) or ammonium phosphate(s) is obtained in the bottom of the washing tower and a vapour which is free from nitrogen compounds is formed. The addition of acid (phosphoric acid or sulphuric acid) further acidifies the solution, so that the equilibrium NH₃+H₃O ⇄=NH₄⁺+H₂O is displaced to the side of the ammonium ion (NH₄⁺) or the ammonium salt. In contrast to the ammonium phosphates or ammonium sulphates, ammonium ions are very easy to electrolyse, pass through the membrane located in the electrochemical cell and thus arrive at the cathode chamber in which an ammoniacal solution is formed therefrom.

By means of step b3), the acids used in step b2) are immediately recovered. This constitutes a valuable material and is immediately recycled in step b4). Furthermore, during the course of step b3) in the anode chamber, further valuable materials, in particular an ammoniacal solution and hydrogen, are obtained which are withdrawn in accordance with b4).

The medium remaining behind in step b) is still flowable and therefore has a low viscosity. Any inorganic components have already settled out in step b) in the reactor, whereupon these are very effectively separated in step c). The inorganic fraction obtained by means of step c) contains inorganic components which are insoluble in the medium, for example heavy metal salts, gravel or sand. In particular, any heavy metal salts are quantitatively separated out of the molecule. Valuable materials, in particular any heavy metals, can be extracted from the inorganic fraction. In contrast to the ash left behind following incineration, any heavy metals contained in the inorganic fraction are not bound into an inorganic matrix, so that further treatment of the inorganic fraction is readily possible. Because of the early separation of any inorganic components, subsequently, it is additionally possible to carry out further treatment of the medium which still contains organic compounds substantially free from side reactions. In addition, subsequently, ash-free organic compounds which can be incinerated can be obtained from the medium, in particular by means of further preferred variations to the method of the invention.

Thus, by means of the method in accordance with the invention, the obstacles to use which were formerly present such as, for example, removing heavy metals contained in the waste and the frequently very high water content in the waste, can be overcome, whereupon an economical extraction of many of the valuable materials from the chemical compounds contained in the waste is made possible.

Preferred variations of the method will be described below.

In particular, step a) is carried out first in the reactor. Particularly preferably, step a) is carried out in a separate mixer, whereupon initially, the medium is formed and is then introduced into the reactor. This means that it can be transported particularly readily. Preferably again, in step a), the waste and the base are heated to 60° C. to 70° C. In this manner, the pumpability of the medium is improved, whereupon in the medium, first decomposition reactions of the organic compounds, or at least those occurring first in step b), can occur.

Preferably, in step a), the waste is mixed with an aqueous potassium hydroxide solution, an aqueous sodium hydroxide solution, an aqueous potassium carbonate solution, an aqueous sodium carbonate solution or with a mixture of at least two of these solutions. In particular, the waste in question, for example sewage sludge, often already contains potassium. These bases are known industrial chemicals the handling of which has advantageously been thoroughly tested and is unproblematic.

Preferably again, in step a), the quantity and/or the concentration of the base is selected in a manner such that the liquid medium formed has a pH of 9.0 to 14.0, in particular of at least 12.0, wherein preferably, the proportion of the dry matter contained in the waste with respect to the base is 1:1 to 1:2. In this manner, the organic compounds are hydrolysed to a particularly good extent. In addition, at this pH, in particular in combination with heating the medium to more than 100° C. in step b), all or almost all of the microorganisms are killed.

In step b), the liquid medium is preferably heated to its boiling temperature, with stirring. Any risk of superheating is reduced thereby.

In accordance with a further preferred variation, in step b), a sulphide solution, in particular a potassium sulphide or a sodium sulphide solution, is added. Sulphides dissolve in the liquid medium, and together with any heavy metals present in the medium, form low-solubility heavy metal sulphides which settle out of the medium. The precipitated heavy metals are separated in the subsequent step c) and are components of the aforementioned solid inorganic phase. Adding a sulphide solution is particularly advantageous when the waste employed has a high heavy metal content and/or is free from sulphur-containing compounds. Because potassium hydroxide solution or sodium hydroxide solution is preferably already being used in step a), potassium sulphide or sodium sulphide solution is particularly preferred as the sulphide solution.

In accordance with a preferred variation, in step b3), water is introduced into the cathode chamber. This brings about an osmotic pressure gradient, which imposes a flow from the cathode chamber to the anode chamber, whereupon the diffusion of residual organic anions from the anode chamber into the cathode chamber is prevented. This keeps the membrane between the anode chamber and cathode chamber clean and the quantity of recovered acid in the anode chamber increases.

Preferably, the vapour withdrawn in step b2) is compressed and subsequently used in step b) to heat the medium in the first reactor. The compression increases the temperature and the pressure of the vapour. Because of the rise in pressure of the vapour, the boiling temperature of the water contained in the vapour increases, so that the water vapour of the vapour condenses at a temperature of >100° C. The phase transformation heat of the water contained in the liquid medium is recovered in this manner and used to heat the medium of a subsequent charge in the first reactor to the temperature required for hydrolysis.

The solid inorganic phase separated in step c) is preferably processed in accordance with the following steps in succession:
c1) washing the solid inorganic phase with water,
c2) returning the washing solution obtained in step c1) to the first reactor used in step b),
c3) discharging the inorganic phase remaining in step c1).

By means of step c1), any organic salts entrained in the solid inorganic phase are dissolved out therefrom. This washing solution is returned to the first reactor in step c2), so that these organic salts are introduced into the actual treatment process and from this, as already described, other valuable materials are extracted. As already mentioned, valuable materials may also be recovered from the heavy metal inorganic fraction.

In accordance with a preferred variation of the method, after step b) and before step c), the following steps are carried out one after the other:
d) transferring the liquid medium obtained in step b) into a second reactor,
e) heating the medium in the second reactor to a temperature of 50° C. to 80° C. under an absolute pressure of 0.02 bar to 0.9 bar, and withdrawing the vapour which is formed.

In accordance with a preferred alternative variation of the method, after step c), the following steps are carried out one after the other:
d) transferring the liquid medium obtained in step c) into a second reactor,
e) heating the medium in the second reactor to a temperature of 50° C. to 80° C. under an absolute pressure of 0.02 bar to 0.9 bar, and withdrawing the vapour which is formed.

In accordance with these two variations of the method, therefore, the medium is transferred into a second reactor and is heated therein under vacuum. In this regard, it is possible to carry out step c)—the separation of any solid inorganic phase contained in the liquid medium—at different points in time during the method, namely before or after transferring the medium to the second reactor. Providing a second reactor is particularly advantageous when the medium has a high water content. In particular, this means that with media with a very high water content such as sewage sludge or manure, for example, the concentration of the organic compounds in the medium can be increased particularly significantly.

The selected maximum temperature of 80° C. which is lower in step e) than in step b) ensures that the organic compounds formed by the preceding hydrolysis (step b) are not decomposed and thus remain unchanged in the liquid medium. In like manner to the vapour already formed in step b), valuable materials can be recovered from the vapour formed in step e). The liquid medium obtained after step e) contains organic compounds in a particularly high concentration and is easily accessible for treatment, for example distillation, so that further valuable materials can be extracted.

The vapour formed in step e) is preferably processed in accordance with the following steps in succession:
e1) transferring the vapour from the second reactor to a second washing tower,
e2) adding sulphuric acid or phosphoric acid to the vapour in order to form ammonium sulphate(s) or ammonium phosphate(s), whereupon a solution is obtained in the bottom of the washing tower,
e3) transferring the solution obtained in e2) to an electrochemical cell with a cathode chamber and an anode chamber and electrolysing the solution, whereupon sulphuric acid or phosphoric acid for step e2) is obtained in the anode chamber,
e4) returning the sulphuric acid or phosphoric acid recovered from the anode chamber to the washing tower and withdrawing the valuable materials formed in the cathode chamber, in particular an ammoniacal solution.

Processing of this vapour is therefore analogous to processing of the vapour obtained in step b).

In accordance with a preferred variational embodiment of the invention, the liquid medium obtained after the last of steps a) to e)—depending on the sequence, after step c) or after step e)—is processed in accordance with the following steps in succession:
f) transferring, in particular continuously transferring, the liquid medium into a third reactor,
g) mixing the medium with a heat transfer oil and heating the medium to 220° C. to 380° C., in particular to at most 300° C., preferably to at most 230° C., under an absolute pressure of 0.02 bar to 0.9 bar,
h) withdrawing the vapour formed in step g) and processing the vapour,
i) withdrawing the suspension of heat transfer oil and a solid organic phase remaining in step b) and processing the suspension.

The medium remaining in step e) is mainly of a highly viscous consistency. By means of step g), the viscous medium is dispersed in heat transfer oil, whereupon a very good transfer of heat to the viscous medium is made possible. The vapour formed contains organic compounds, in particular alkanes, ketones, esters, alcohols and ethers, and thus is rich in valuable materials. In particular, in accordance with further preferred variational embodiments of the invention, valuable materials may also be obtained from the remaining suspension, as will be explained in more detail below.

The vapour withdrawn in accordance with step h) is preferably processed in accordance with the following steps in succession:
h1) withdrawing the vapour formed to a distillation column,
h2) cooling the vapour in the distillation column, in particular by spraying in water, in order to condense organic compounds,
h3) withdrawing the organic compounds condensed in step h2) and withdrawing the vapour remaining in step h2).

The distillation column is therefore operated in a manner such that organic compounds which have a lower vapour pressure than water settle out in the bottom of the distillation column and a vapour which primarily contains water vapour rises into the head of the distillation column. The organic compounds constitute a further valuable material which in particular is used directly for power generation or for recovering further valuable materials.

The remaining vapour in particular contains reformed gases which are thermally or physically processed, for example in internal combustion heat engines such as, for example, gas engines, diesel engines or gas turbines.

The suspension withdrawn in accordance with step i) formed from heat transfer oil and solid organic phase is preferably processed in accordance with the following steps in succession:
i1) withdrawing the suspension to a separator and adding a phase containing water, whereupon an aqueous phase and a supernatant phase are formed in the separator,
i2) returning the supernatant phase from the separator to the third reactor and transferring the aqueous phase to a conversion device,
i3) in the conversion device, converting polar organic salts dissolved in the aqueous phase into organic compounds, in particular hydrocarbons and carbon dioxide, as well as into hydrogen,
i4) returning the liquid medium obtained in step i3) to the separator.

The solid organic phase is formed by organic salts. These are initially not accessible to distillation. By means of step i1), these organic salts are converted into an aqueous phase. By means of step i3), further distillable organic compounds are obtained from the organic salts. By means of step i4), they come into contact with the heat transfer oil (supernatant phase) in which they are eluted. In accordance with step i2), the heat transfer oil, and along with it the further distillable organic compounds obtained, are recycled to the third reactor. The further treatment (valuable material recovery) is then carried out in accordance with the aforementioned steps g) and h) as well as, preferably, in accordance with the steps h1) to h3).

In particular, the water-containing phase supplied to step i1) is the liquid medium obtained in step i4).

In order to obtain further valuable materials, in accordance with a further preferred variation, the aqueous phase formed in step i1), preferably after passing through steps i3) and i4) at least once, are passed into an electrochemical cell with two half cells separated by an ion-permeable alkali metal membrane and is electrolysed therein. The aqueous phase still contains potassium carbonate, possibly residual potassium hydroxide and in particular also potassium phosphate, and constitutes an electrolyte solution. By means of the application of direct current/direct voltage, hydrogen and potassium hydroxide are formed at the cathode. Caustic potash is formed from potassium hydroxide. Phosphoric acid and oxygen are formed at the anode. The caustic potash obtained is preferably used in step a). Any superfluous caustic potash is in particular utilized commercially. The phosphoric acid may, for example, be fed to the washing towers (step b2) and step e2). The hydrogen obtained also, in known manner, constitutes a valuable material and is, for example, best suited to power generation in a combustion engine or in a fuel cell.

In accordance with a first alternative preferred variation, the liquid medium obtained in step b), preferably in step c), is pyrolyzed at a temperature of at most 500° C. Because the medium has been filtered by means of a separating device (step c), the medium is advantageously free from any heavy metal inorganic compounds. Because the medium, with the exception of alkali compounds, is also free from any inorganic components, the pyrolysis occurs without or at least substantially without side reactions so that, compared with conventional pyrolysis, significantly higher yields of liquid products can be obtained.

In accordance with a second alternative preferred variation, the liquid medium obtained in step b), preferably in step c), is gasified, in particular by means of entrained flow gasification, fluidized bed gasification or fixed bed gasification, preferably by means of counter current fixed bed gasification.

In accordance with a third alternative, preferred variation, the liquid medium obtained in step b), preferably in step c), is incinerated.

Carrying out said thermal method with the medium from which, in accordance with step c), any solid inorganic phase has been separated out, is advantageous because the thermal method in this variation is carried out without or substantially without side reactions. In this manner, compared with conventional thermal methods, particularly high yields of valuable materials are obtained.

Further features, advantages and details of the invention will now be described in more detail with the aid of the single FIGURE,

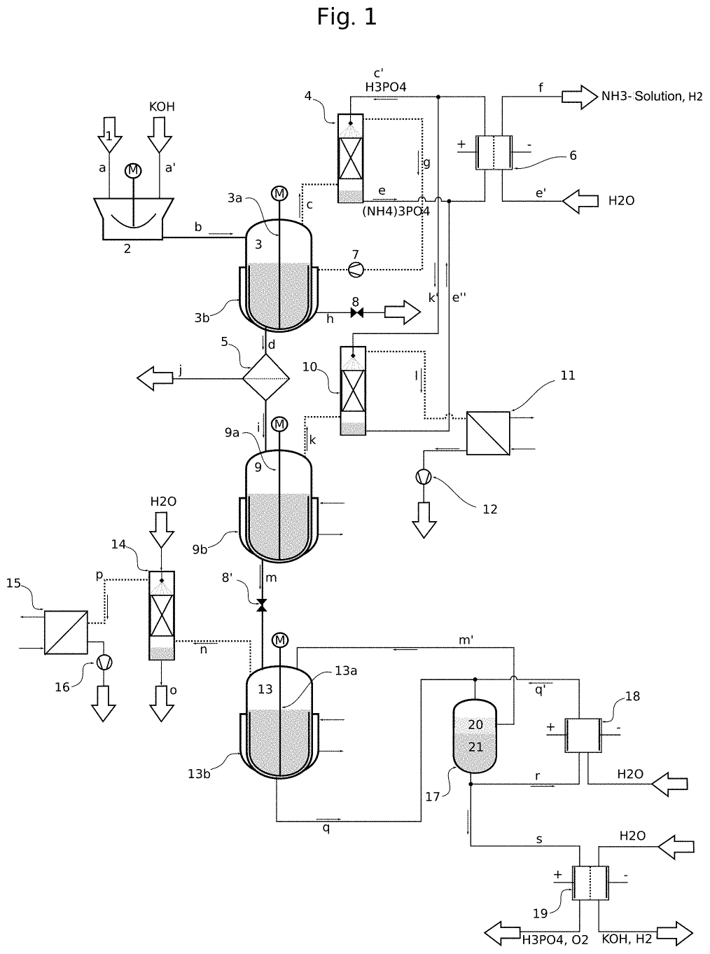

FIG. 1, which shows a diagrammatic flow diagram of a method in accordance with one variational embodiment of the invention.

In the context of the present invention, the term “liquid medium” encompasses liquids, suspensions and emulsions as well as mixtures of suspensions and emulsions.

The invention concerns a method for recovering valuable materials from organic compounds contained in waste or chemical elements contained therein. Particularly suitable organic compounds are triacylglycerols (fats and fatty oils), proteins, carbohydrates or lignins.

Particular chemical elements contained in waste which are suitable for valuable material extraction are nitrogen, phosphorus and/or potassium, which are the usual components of the molecules of the organic compounds. They are therefore in an “organic matrix”. Nitrogen, for example, is present in the amino acids of proteins. Organic phosphates such as phospholipids, for example, which, as is well known, are components of cell membranes, nucleic acids or phytates found in corn and soya residues, contain phosphorus in the bound form. Furthermore, inorganic phosphates, for example calcium phosphate originating from animal bones, may also be contained in waste. Frequently, the waste is also loaded with heavy metals; as an example, waste water from biowaste fermentation plants may contain copper or zinc.

One example of a type of waste which comes into question is manure, which contains potassium as potassium salts, nitrogen as amines or ammonium (NH₄) and phosphorus as phosphate(s). Further particular types of waste which are suitable for the extraction of valuable materials are waste from slaughterhouses or sewage sludge, wherein sewage sludge contains phosphorus, potassium and nitrogen in the bound form. In particular, nitrogen is bound into amines.

Preferably, the waste is a biogenic waste (waste of biogenic origin). The table below (Table 1) contains some information on biogenic waste regarding its usual dry matter content as well as the proportions by weight of potassium, nitrogen and phosphorus. The numbers given should be understood to be guidelines.

TABLE 1

| | Dry matter | Potassium | Nitrogen | Phosphorus |
|---|---|---|---|---|
| | content | content | content | content |
| Waste | [%] | [%] | [%] | [%] |
| Municipal | 20 | 0.5 | 6 | 6 |
| sewage sludge | | | | |
| Pig manure | 5 | 3.5 | 5 | 3.5 |
| Chicken manure | 50 | 25 | 24 | 20 |
| Fermentation | 5 | 4 | 5 | 2 |
| residues from | | | | |
| biogas | | | | |

A liquid medium produced from the waste passes between the individual steps of the method through different successive devices and is processed therein. Material flows a to s as well as material flows a′, c′, e′, k′, m′, q′ and e″ in FIG. 1 indicate transport of the liquid medium or transport of components separated out from the medium. Flows which are indicated by the same letters, such as a, a′, for example, flow into the same device or the same component of the device. Pipes, pumps, shut-off devices, for example valves, and the like in particular are provided in order to transport the media or its components.

As indicated in FIG. 1, the relevant waste 1 is introduced into a mixer 2 (material flow a), in which an aqueous potassium hydroxide solution (“caustic potash”, material flow a′) is introduced and mixed with the waste, so that a liquid, pumpable medium is formed. Any decomposition reactions of the organic compounds contained in the waste which occur in the mixer 2 contribute to homogenization of the medium and improve its pumpability. Preferably, the medium is heated in the mixer 2 to 60° C. to 70° C. for example, in order to accelerate or favour the decomposition reactions. The quantity of added potassium hydroxide solution and/or the concentration of the potassium hydroxide solution is preferably selected in a manner such that the liquid medium formed has a pH of 9.0 to 14.0, in particular of at least 12.0. Particularly preferably, the proportion of organic dry matter to potassium hydroxide contained in the waste is 1:1 to 1:2. The homogenized liquid medium obtained is transferred into a hydrolysis reactor 3 (material flow b). The waste 1 and the aqueous potassium hydroxide solution may also be introduced directly into the hydrolysis reactor 3, i.e. without having previously been mixed in the mixer 2, in particular by means of a hose system.

The hydrolysis reactor 3 has a stirrer 3a and a heating jacket 3b and is preferably operated under environmental pressure and therefore at an absolute pressure of ca. 1.0 bar. In particular, the hydrolysis reactor 3 may be operated at an absolute pressure of 0.02 bar to 1.0 bar. In the hydrolysis reactor 3, the liquid medium is heated, with stirring, to 100° C. to 140° C., in particular to at most 120° C., whereupon alkaline hydrolysis is carried out on all of the organic compounds contained in the medium. In this regard, from the majority of the organic compounds, organic salts are formed which go into solution in the liquid medium. The anions of the organic salts originate in known manner in particular from organic acids, from proteins or from carbohydrates. In the exemplary embodiment described, the anions originate, for example, from the fatty acids of the triacylglycerols. The organic salts formed therefore usually contain one or more carboxylate group(s) (R—COO—). In the exemplary embodiment described, organic potassium salts are formed—because of the use of caustic potash.

Because caustic potash is used, potassium phosphates are formed from any bound phosphorus; at the selected pH of at least 9.0, potassium triphosphates are formed in particular, which go into solution. Therefore, in addition, inorganic potassium salts are also formed which dissolve in the medium.

Any bound nitrogen, for example amino acids originating from proteins, is decomposed in known manner by means of nucleophilic substitutions, in particular by means of S_{N}2 reactions, at least for the most part into ammonium, organic acids and their salts.

Bound sulphur which is present, for example as sulphur-containing proteins such as cysteine, for example, forms hydrogen sulphide and/or sulphides upon hydrolysis. Sulphides which are formed dissolve in the liquid medium and, together with any heavy metals present in the medium, form low-solubility heavy metal sulphides which settle out of the medium. If no sulphur-containing compounds are supplied with the waste, a sulphide solution, in particular a potassium sulphide solution, is introduced into the hydrolysis reactor 3 in a manner which is not shown and causes the precipitation of the heavy metals in this manner.

In particular, during hydrolysis, carbon dioxide is also formed, which reacts with caustic potash to form potassium carbonate which dissolves easily in the medium. Any potassium salts which in particular originate from plants and animal bones will, at least to a major extent, form insoluble potassium carbonates with the carbon dioxide.

Inorganic components which are not dissolved or are insoluble in the medium, which optionally have been mixed with the as yet undissolved organic compounds, sediment out and form a solid inorganic phase. Examples of these inorganic components are gravel, sand as well as the aforementioned calcium salts and heavy metal sulphides. Depending on the waste, the solid inorganic phase may also contain further components.

The vapour formed during the hydrolysis consists of water vapour and gaseous nitrogen compounds such as ammonia or amines, for example, and is fed from the hydrolysis reactor 3 into a washing tower 4 (material flow c). The remaining hydrolysed liquid medium is transferred along with the precipitated solid inorganic phase from the hydrolysis reactor 3 into a mechanical separating device 5 (material flow d) and is further processed therein, as is yet to be described.

The vapour containing nitrogen compounds fed into the washing tower 4 is supplemented therein with phosphoric acid (H₃PO₄) which, in known manner, is sprayed into the washing tower 4 from above (material flow c′). In this manner, an ammonium phosphate, for example (NH₄)₃PO₄, is formed in the bottom of the washing tower 4. A vapour which is substantially free from nitrogen compounds rises to the head of the washing tower 4. Instead of the phosphoric acid, sulphuric acid (H₂SO₄) may also be used, so that ammonium sulphate forms in the bottom of the washing tower 4. By adding the acid (phosphoric acid or sulphuric acid), the equilibrium NH₃+H₃O⇄NH₄⁺+H₂O is displaced to the side of the ammonium ions (NH₄⁺) or ammonium salts. In contrast to the ammonium phosphates or ammonium sulphates, the ammonium ions are highly accessible to electrolysis.

The solution that has dropped into the bottom of the washing tower 4 is transferred into at least one electrochemical cell 6 (material flow e), in which the phosphoric acid (H₃PO₄) or sulphuric acid (H₂SO₄) is recovered. The electrochemical cell 6 has two half cells separated by a membrane, namely a cathode chamber and an anode chamber, wherein the solution from the washing tower 4 is introduced into the anode chamber. By means of electrolysis, from the respective ammonium salts in the cathode chamber (more precisely: ammonium ions migrating from the anode chamber through the membrane into the cathode chamber) with the supply of water (material flow e′), ammoniacal solution and hydrogen are obtained; in the anode chamber, phosphoric acid or sulphuric acid are recycled, with the simultaneous formation of oxygen. By supplying water to the cathode chamber, an osmotic pressure gradient is produced which causes a flow from the cathode chamber to the anode chamber, whereupon the diffusion of residual organic anions from the anode chamber to the cathode chamber is prevented. In this manner, the membrane is kept clean. The ammoniacal solution obtained and the hydrogen obtained are withdrawn from the cathode chamber (material flow f) and can be processed in known manner as recovered valuable materials. The recycled phosphoric or sulphuric acid as well as the oxygen formed are introduced into the washing tower 4 from the anode chamber (material flow c′).

The vapour which rises to the head of the washing tower 4 and which is substantially free from nitrogen compounds is initially passed through a compressor 7, wherein the temperature and pressure of the vapour is raised, and subsequently fed to the heating jacket 3b of the hydrolysis reactor 3 (material flow g). Because the pressure of the vapour is raised, the boiling temperature of the water contained in the vapour rises, so that the water vapour of the vapour in the heating jacket 3b condenses at a temperature of >100° C. The phase transformation heat of the water contained in the liquid medium is recovered in this manner and used to heat the medium of a subsequent charge in the hydrolysis reactor 3 to the preferred aforementioned temperature of 100° C. to 140° C. for hydrolysis. The condensate formed from the vapour is withdrawn from the heating jacket 3b (material flow h), wherein the pressure is maintained by means of a valve 8, and thus the high temperature of the previously compressed vapour prior to withdrawing it as a condensate is guaranteed.

As already mentioned, the hydrolysed liquid medium is transferred from the hydrolysis reactor 3 into the separating device 5 which, for example, is a screen belt filter or a peeler centrifuge (material flow d). The aforementioned solid inorganic phase is separated out of the hydrolysed liquid medium by means of the separating devices and subsequently is preferably washed with water, whereupon in particular, any organic salts still contained therein, in particular organic potassium salts, are dissolved out. The washing solution obtained during the washing process is recycled to the hydrolysis reactor in a manner which is not shown and is evaporated therein again together with the next charge in the manner which has already been described. The solid inorganic phase is mechanically removed from the separating device 5 and constitutes an inorganic fraction containing heavy metals (material flow j), from which heavy metals, for example copper, chromium or cadmium, can be obtained as valuable materials. The filtered liquid medium contains the dissolved organic salts such as organic potassium salts, for example, dissolved inorganic phosphates, dissolved potassium carbonate and possibly also small quantities of nitrogen compounds, and is transferred to a reactor 9 (material flow i).

The reactor 9 is preferably identical in construction to the hydrolysis reactor 3, and therefore has a stirrer 9a and a heating jacket 9b. The filtered liquid medium fed into the reactor 9 is heated to 50° C. to 80° C., in particular to at least 70° C., under an absolute pressure of 0.02 bar to 0.9 bar. The pressure in the reactor 9 is produced by means of a vacuum pump 12 which is disposed behind a heat exchanger 11, as will be explained below.

Under the aforementioned conditions in the reactor 9, any nitrogen compounds which are still present in the liquid medium, for example ammonia and amines, collect in the vapour formed in the reactor 9, which is fed to a washing tower 10 (material flow k). Furthermore, the conditions prevailing in the reactor 9 ensure that the organic compounds formed during the preceding hydrolysis are not decomposed and thus remain unchanged in the liquid medium.

A pressure prevails in the washing tower 10 which is essentially the same as the pressure in the reactor 9. The washing tower 10 is operated in a manner analogous to the washing tower 4 which has already been described. The phosphoric acid or sulphuric acid used in the washing tower 10 for gas scrubbing also originates from the electrochemical cell 6 (material flow k′); correspondingly, the solution which collects in the bottom of the washing tower 4 is supplied to the electrochemical cell 6 (material flow e″).

As indicated by the material flow 1, the vapour which is at least substantially free from nitrogen compounds is fed out of the head of the washing tower 10 via a heat exchanger 11 and condenses therein, whereupon the heat of condensation is withdrawn from the heat exchanger 11. Water vapour and any reformed gases, for example carbon dioxide, are removed via the aforementioned vacuum pump 12.

The medium which remains after heating in the reactor 9 and which is still warm has a liquid or viscous consistency and still contains dissolved organic salts, dissolved inorganic phosphates, dissolved potassium carbonate and, possibly, still small quantities of nitrogen compounds as well as up to ca. 20% water.

This medium is transferred into a reactor 13, in particular via a valve 8′, dosing it slowly thereto (material flow m). The reactor 13 is preferably identical in construction to the hydrolysis reactor 3, and therefore has a stirrer 13a and a heating jacket 13b.

A heat transfer oil, for example a paraffin, is contained in the reactor 13 and improves the transfer of heat to the medium. Intense stirring with the stirrer 13a suspends the medium in the heat transfer oil and it is heated to a temperature of 220° C. to 380° C., preferably up to 300° C. particularly preferably up to 230° C., by means of the heating jacket 13b. For heating, an appropriately pre-heated thermal oil, for example, is passed through the heating jacket 13b. Alternatively, for example, hot waste gases from a cogeneration could be introduced. The absolute pressure in the reactor 13 is 0.02 bar to 0.9 bar and is produced by means of a vacuum pump 16, the exact position of which will become apparent from the description below.

The vapour formed from the medium in the reactor 13 comprises volatile organic compounds, in particular alkanes, ketones, esters, alcohols and ethers, as well as water, and is transferred to a distillation column 14 which is also under vacuum if the reactor 13 is under vacuum (material flow n). In the distillation column 14, the organic compounds contained in the introduced vapour are condensed by spraying water. The distillation column 14 is operated in a manner such that the organic compounds, which have a lower vapour pressure than water, collect in the bottom of the distillation column 14, and a vapour which substantially contains water vapour rises into the head of the distillation column 14. The high boiling point organic compounds collected in the bottom of the distillation column 14 are drawn off (material flow o) and constitute a further valuable material which in particular is used directly for power generation or to obtain further valuable materials. The vapour which substantially contains water vapour is removed via the head of the distillation column 14 (material flow p) and subsequently condenses in a heat exchanger 15. Any reformed gases which have formed in the distillation column 14, for example carbon dioxide, are drawn off together with the vapour out of the head of the distillation column 14 into the heat exchanger 15 and from this are removed by means of the vacuum pump 16. The reformed gases can in particular be processed thermally or physically, for example in internal combustion heat engines such as, for example, gas engines, diesel engines or gas turbines.

A suspension formed by the heat transfer oil and a solid phase formed by inorganic and organic salts (in the exemplary embodiment, potassium salts in particular) remains in the reactor 13. If corresponding phosphorus-containing waste were to be used, then the solid phase would also include phosphates (in the exemplary embodiment, potassium phosphates in particular).

The organic and inorganic salts are polar compounds which are initially not accessible to distillation. Because of the high temperatures in the reactor 13, at least a portion of the salts which are present decompose into organic compounds which are also capable of being distilled and which are transferred into the distillation column 14 (material flow n). In order to recover further organic compounds which are also capable of being distilled from the organic and inorganic salts remaining in the suspension, the procedure described below is followed.

The suspension of heat transfer oil and the solid organic and inorganic salts is transferred from the reactor 13 into a separator 17 (material flow q). Furthermore, a recycle containing water (material flow q′) originating from a converting device 18 is fed into the separator 17. In this recycle, in the separator 17, the organic and inorganic salts suspended in the heat transfer oil are eluted, i.e. the salts are “dissolved out” of the heat transfer oil. In the separator 17—determined by the different densities—a supernatant phase 20 is formed which is formed by heat transfer oil, and an aqueous phase 21 containing the organic salts is formed. The supernatant heat transfer oil is continuously recycled from the separator 17 to the reactor 13 (material flow m′), in which it again improves heat transfer to the medium. In addition, the heat transfer oil in separator 17 also acts as an extraction agent for organic compounds which are contained in the recycle (material flow q′) and are fed into the reactor 13 in this manner. These organic compounds are obtained from the organic salts dissolved in the aqueous phase, as will be explained below.

In order to obtain organic compounds from the organic salts which are capable of being distilled, the aqueous phase 21, which constitutes an electrolyte solution, is fed out of the separator 17 into a converting device 18 (material flow r). The converting device 18 is constructed, for example, in accordance with the as yet unpublished Austrian patent application A50387/2016 and operates in accordance with the process described therein for electrochemical conversion. In particular, the aqueous phase is continuously introduced into and removed from at least one single-chambered electrolysis cell designed as a df cell which has an electrode assembly formed by at least two contact electrodes connected to a voltage source, whereupon it passes through the electrode assembly. The process parameters (residence time for the electrolyte solution in the electrolysis cell, the temperature of the aqueous phase, the pH of the electrolyte solution, the ion concentration of the electrolyte solution, the current strength and the voltage of the voltage source) are set in a manner such that the organic salts in the electrolyte solution are decomposed, wherein organic compounds of different classes of materials, including alkanes, are formed from the inorganic and organic salts at the anode. Furthermore, at the anode, carbon dioxide and oxygen are formed and substantially hydrogen is formed at the cathode. The hydrogen acts as a hydrogenating agent, so that in the region of the cathode, organic compounds of various classes of material are also formed. A possible reaction in the conversion device 18 is a Kolbe electrolysis, in which the organic salts are converted into alkanes, into further organic compounds as well as into carbon dioxide. Carbon dioxide which is formed reacts with the caustic potash which is still present in order to form potassium carbonate. Furthermore, the organic compounds may also be partially oxidized. As indicated in FIG. 1, the conversion in the conversion device 18 is preferably carried out with the addition of water. In this regard, the conductivity of the electrolyte solution is improved because the possibility of exceeding the limiting conductivity of a saturated salt solution is avoided. In addition, in this manner, the recycle which is returned from the conversion device 18 to the separator 17 (material flow q′) correspondingly contains water, whereupon the elution of the organic salts in the separator 17 described above and the phase separation taking place therein is made possible.

The liquid mixture contained in the conversion device 18 is recycled to the separator 17 (material flow q′) and comes into contact with the heat transfer oil therein. The organic compounds formed during the conversion are lipophilic, so that they now dissolve well in the heat transfer oil which now also functions as an extraction agent. The aqueous phase of the liquid mixture collects in the lower region of the separator 17. By means of the aforementioned recycle of the heat transfer oil to the reactor 13, the distillable organic compounds formed in the conversion device 18 are recycled to the reactor 13 (material flow m′). Thus, by means of the conversion device 18, organic salts which are collected in the bottom of the reactor 13 and which are dissolved in an aqueous phase are converted into distillable organic compounds (hydrocarbons), from which further valuable materials are obtained in the manner described above (material flows n, o and p). The respective aqueous phase collecting in the reactor 13 can be prepared multiple times in the manner described, so that the organic and inorganic salts are substantially completely removed from the aqueous phase and valuable materials are obtained therefrom.

If no further conversion step for the aqueous phase is provided by means of the conversion device 18, the aqueous phase which is almost completely free from organic salts is fed out of the separator 17 into an electrochemical cell 19 (material flow s). The aqueous phase still contains inorganic salts, in particular potassium salts, potassium carbonate, potassium hydroxide and potassium phosphate in the exemplary embodiment, and constitutes an electrolyte solution. As already discussed, potassium carbonate was formed during hydrolysis in the hydrolysis reactor 3 and in the conversion device 18. Potassium hydroxide originates from the added caustic potash. Potassium phosphate originates from any phosphorus contained in the waste, which is reacted with the caustic potash in the hydrolysis reactor 3, again as already discussed.

The electrochemical cell 19 is preferably divided, by means of a membrane which is permeable to potassium ions, into two half cells—an anode chamber and a cathode chamber. By means of the application of direct current/direct voltage, the potassium ions migrate through the membrane into the cathode chamber and, together with the added water, form hydrogen and potassium hydroxide at the cathode, whereupon caustic potash is formed. In the anode chamber, phosphoric acid, oxygen and carbon dioxide are formed at the anode. The caustic potash is withdrawn from the cathode chamber, the phosphoric acid is withdrawn from the anode chamber, the oxygen and hydrogen gas which are formed are also withdrawn. By adding water to the cathode chamber, the loss on diffusion of phosphate through the membrane is kept low and clogging of the membrane is effectively prevented. Furthermore, the addition brings about an osmotic gradient in the direction of the anode chamber.

The caustic potash obtained is preferably used in the mixer 2 in the manner described above (material flow a′). Any superfluous caustic potash is in particular utilized commercially. The phosphoric acid may, for example, be supplied to the washing towers 4 and 10 and used for the washing processes which have been described (material flows c′ and k′). The caustic potash obtained and the phosphoric acid obtained are further valuable materials. The hydrogen obtained in the electrochemical cell 19 also constitutes a valuable material in known manner and in particular is best suited to power generation in a combustion engine or in a fuel cell.

Materials or valuable materials from the following group are obtained in the described exemplary embodiment, and as a function of the respective waste:
water,
ammonia (as ammoniacal solution),
phosphoric acid or sulphuric acid (respectively as an aqueous solution),
potassium (as caustic potash),
inorganic components, which in particular includes metals (apart from those which belong to the first group of the periodic table) wherein in particular, the metals are obtained as salts, oxides or hydroxides,
hydrogen,
oxygen,
other gases (nitrogen, water vapour, carbon dioxide, trace gases).

The invention is not limited to the exemplary embodiment described. Instead of potassium hydroxide solution (material flow a′), an aqueous potassium carbonate solution, an aqueous sodium hydroxide solution or an aqueous sodium carbonate solution may be used.

Furthermore, mixtures of solutions of this type may be used. Sodium hydroxide solution and sodium carbonate solution particularly advantageous for the hydrolysis of waste which already contains sodium, for example waste of marine origin, such as waste containing algae in particular. In the electrochemical cell 19, a potassium hydroxide solution (caustic potash) and/or a sodium hydroxide solution (caustic soda) may be obtained in a manner analogous to that already described. Any carbon dioxide which is generated in the electrochemical cell 19 is withdrawn.

In accordance with an alternative variational embodiment, it is envisaged that valuable materials could be obtained from the liquid or viscous medium remaining after heating in the reactor 9 (material flow m) by means of a thermal process. As already discussed, the medium contains dissolved organic salts, dissolved inorganic phosphates and up to ca. 20% water.

A first possibility is pyrolysis of the medium originating from the reactor 9. Because of the upstream hydrolysis of the medium in the hydrolysis reactor 3, the molecular weight of the organic molecules contained in the waste has been significantly reduced. This means that it is possible to carry out the pyrolysis at a lower temperature for the pyrolysis, wherein the medium is preferably pyrolyzed at a temperature of at most 500° C. As an example, potassium acetate could be used as the organic salt during the hydrolysis. This decomposes during pyrolysis into acetone and potassium carbonate at as low a temperature as approximately 300° C.

Because, furthermore, the medium has been filtered by means of the separating device 5, the medium is free from any inorganic compounds containing heavy metals. In contrast to conventional pyrolysis, in which the heavy metals are deposited in pyrolytic coke, the pyrolytic coke which is generated during pyrolysis of a medium originating from the reactor 9 is not a problem in this regard. Because, with the exception of alkali compounds, the medium is free from any inorganic components, the pyrolysis is carried out without or at least substantially without side reactions. In this manner, during the pyrolysis of the medium originating from the reactor 9, compared with conventional pyrolysis, significantly higher yields of liquid products are obtained.

In accordance with a second possibility, the medium originating from the reactor 9 is incinerated.

In accordance with a third possibility, the medium originating from the reactor 9 is gasified. The gasification is in particular carried out by means of entrained flow gasification, fluidized bed gasification or fixed bed gasification. Fixed bed gasification in a counter current fixed bed gasifier is particularly suitable, in which the medium is heated in a particularly conservative manner, whereupon high yields of liquid organic compounds are obtained.

The aforementioned valuable materials (phosphoric acid, ammoniacal solution, potassium hydroxide solution and sodium hydroxide solution) can also be obtained in the electrochemical cells 6 and 19 by means of capacitative deionization.

### LIST OF REFERENCE NUMERALS

1 waste
2 mixer
3 hydrolysis reactor
3a stirrer
3b heating jacket
4 washing tower
5 separating device
6 electrochemical cell
7 compressor
8 valve
9 reactor
9a stirrer
9b heating jacket
10 washing tower
11 heat exchanger
12 vacuum pump
13 reactor
13a stirrer
13b heating jacket
14 distillation column
15 heat exchanger
16 vacuum pump
17 separator
18 conversion device
19 electrochemical cell
20 supernatant phase
21 aqueous phase

1. A method for extracting valuable materials from organic compounds contained in waste or chemical elements contained therein, the method comprising the following steps being carried out in succession:
a) mixing the waste with a base so that a liquid medium is formed,
b) heating the medium in a reactor to a temperature of 100° C. to 140° C. in order to hydrolyse the organic compounds contained in the medium, and withdrawing the vapour which is formed,
b1) transferring the vapour from the reactor to a washing tower,
b2) adding sulphuric acid or phosphoric acid to the vapour in order to form ammonium sulphate(s) or ammonium phosphate(s), wherein a solution is obtained in the bottom of the washing tower and the vapour is withdrawn from the head of the washing tower,
b3) transferring the solution obtained in step b2) to an electrochemical cell with a cathode chamber and an anode chamber and electrolysing the solution, whereupon in the anode chamber, sulphuric acid or phosphoric acid is obtained for step b2), and
b4) recycling the sulphuric acid or phosphoric acid obtained from the anode chamber to the washing tower and withdrawing valuable materials formed in the cathode chamber, in particular an ammoniacal solution, and
c) transferring the liquid medium remaining in the reactor in step b) to a separating device in order to separate any solid inorganic phase which is contained in the liquid medium.

2. The method as claimed in claim 1, wherein step a) is carried out first in the reactor.

3. The method as claimed in claim 1, wherein step a) is carried out in a separate mixer.

4. The method as claimed in claim 3, wherein in step a), the waste and the base are heated to 60° C. to 70° C.

5. The method as claimed in claim 1, wherein in step a), the waste is mixed with an aqueous potassium hydroxide solution, an aqueous sodium hydroxide solution, an aqueous potassium carbonate solution, an aqueous sodium carbonate solution or with a mixture of at least two of these solutions.

6. The method as claimed in claim 1, wherein in step a), the quantity and/or the concentration of the base is selected in a manner such that the liquid medium formed has a pH of 9.0 to 14.0, in particular of at least 12.0, wherein preferably, the proportion of the dry matter contained in the waste with respect to the base is 1:1 to 1:2.

7. The method as claimed in claim 1, wherein in step b), the liquid medium is heated to its boiling temperature, with stirring.

8. The method as claimed in claim 1, wherein in step b), a potassium sulphide or a sodium sulphide solution, is added.

9. The method as claimed in claim 1, wherein in step b3), water is introduced into the cathode chamber.

10. The method as claimed in claim 1, wherein the vapour withdrawn in step b2) is compressed and subsequently used in step b) to heat the medium in the reactor.

11. The method as claimed in claim 1, wherein solid inorganic phase separated in step c) is extracted in accordance with the following steps in succession:
c1) washing the solid inorganic phase with water,
c2) returning the washing solution obtained in step c1) to the reactor used in step b), and
c3) discharging the inorganic phase remaining in step c1).

12. The method as claimed in claim 1, wherein after step b) and before step c), the following steps are carried out one after the other:
d) transferring the liquid medium obtained in step b) into a second reactor, and
e) heating the medium in the second reactor to a temperature of 50° C. to 80° C. under an absolute pressure of 0.02 bar to 0.9 bar, and withdrawing the vapour which is formed.

13. The method as claimed in claim 1, wherein after step c), the following steps are carried out one after the other:
d) transferring the liquid medium obtained in step c) into a second reactor, and
e) heating the medium in the second reactor to a temperature of 50° C. to 80° C. under an absolute pressure of 0.02 bar to 0.9 bar, and withdrawing the vapour which is formed.

14. The method as claimed in claim 13, wherein the vapour formed in step e) is processed in accordance with the following steps in succession:
e1) transferring the vapour from the second reactor to a second washing tower,
e2) adding sulphuric acid or phosphoric acid to the vapour in order to form ammonium sulphate(s) or ammonium phosphate(s), whereupon a solution is obtained in the bottom of the washing tower,
e3) transferring the solution obtained in e2) to an electrochemical cell with a cathode chamber and an anode chamber and electrolysing the solution, whereupon sulphuric acid or phosphoric acid for step e2) is obtained in the anode chamber, and
e4) returning the sulphuric acid or phosphoric acid recovered from the anode chamber to the washing tower and withdrawing the valuable materials formed in the cathode chamber, in particular an ammoniacal solution.

15. The method as claimed in claim 13, wherein the liquid medium obtained after the last of steps a) to e)—depending on the sequence, after step c) or after step e)—is processed in accordance with the following steps in succession:
f) transferring, in particular continuously transferring, the liquid medium into a third reactor,
g) mixing the medium with a heat carrier oil and heating the medium to 220° C. to 380° C., in particular to at most 300° C., preferably to at most 230° C., under an absolute pressure of 0.02 bar to 0.9 bar,
h) withdrawing the vapour formed in step g) and processing the vapour, and
i) withdrawing the suspension of heat carrier oil and a solid organic phase remaining in step b) and processing the suspension.

16. The method as claimed in claim 15, wherein vapour withdrawn in accordance with step h) is processed in accordance with the following steps in succession:
h1) withdrawing the vapour formed to a distillation column,
h2) cooling the vapour in the distillation column, in particular by spraying in water, in order to condense organic compounds, and
h3) withdrawing the organic compounds condensed in step h2) and withdrawing the vapour remaining in step h2).

17. The method as claimed in claim 15, wherein the suspension withdrawn in accordance with step i) formed from heat transfer oil and solid organic phase is processed in accordance with the following steps in succession:
i1) withdrawing the suspension to a separator and adding a phase containing water, whereupon an aqueous phase and a supernatant phase are formed in the separator,
i2) returning the supernatant phase from the separator to the third reactor and transferring the aqueous phase to a conversion device,
i3) in the conversion device, converting polar organic salts dissolved in the aqueous phase into organic compounds, in particular hydrocarbons and carbon dioxide, as well as into hydrogen, and
i4) returning the liquid medium obtained in step i3) to the separator.

18. The method as claimed in claim 17, wherein the water-containing phase supplied to step i1) is the liquid medium obtained in step i4).

19. The method as claimed in claim 17, wherein the aqueous phase formed in step i1), after passing through steps i3) and i4) at least once, are passed into an electrochemical cell with two half cells separated by an ion-permeable alkali metal membrane and is electrolysed therein.

20. The method as claimed in claim 1, wherein the liquid medium obtained in step b) or in step c), is pyrolyzed at a temperature of at most 500° C.

21. The method as claimed in claim 1, wherein the liquid medium obtained in step b) or in step c), is gasified, in particular by means of entrained flow gasification, fluidized bed gasification or fixed bed gasification, preferably by means of counter current fixed bed gasification.

22. The method as claimed in claim 1, wherein the medium obtained in step b) or in step c), is incinerated.
